(19) United States
(12) Patent Application Publication
(10) Pub. No.: US 2016/0203645 A1
(43) Pub. Date: Jul. 14, 2016

(54) SYSTEM AND METHOD FOR DELIVERING AUGMENTED REALITY TO PRINTED BOOKS

(71) Applicants: MARJORIE KNEPP, ANN ARBOR, MI (US); CHRISTINA YORK, ANN ARBOR, MI (US); JOHN YORK, ANN ARBOR, MI (US); SEAN YALDA, FERNDALE, MI (US); Seth Archambault, DETROIT, MI (US)

(72) Inventors: MARJORIE KNEPP, ANN ARBOR, MI (US); CHRISTINA YORK, ANN ARBOR, MI (US); JOHN YORK, ANN ARBOR, MI (US); SEAN YALDA, FERNDALE, MI (US); Seth Archambault, DETROIT, MI (US)

(21) Appl. No.: 14/991,755

(22) Filed: Jan. 8, 2016

Related U.S. Application Data
(60) Provisional application No. 62/101,967, filed on Jan. 9, 2015.

(51) Int. Cl. G06T 19/00; G06T 15/00; G06F 3/0346

(52) U.S. Cl. CPC G06T 19/006; G06F 3/0346; G06T 15/005; G06T 2200/28

(57) ABSTRACT

An augmented reality system that provides multi-media presentations super-imposed on and presented with a standard printed book. An user electronic appliance, possessing a display screen, a camera, and a software application, takes an image of a printed page. A unique visual identifier is associated with each page. A multi-media presentation, including a video component, an audio component, and, optionally, a haptic component, is associated with unique visual identifier. When the software application detects a printed page, it creates the unique visual identifier and transmits it to a remote server and database. The remote server and database transmits the multi-media presentation, in return. The user electronic appliance plays and presents the multi-media presentation.

### CLAIM OF PRIORITY

This U.S. utility patent application claims priority to U.S. provisional application No. 62/101,967.

### FIELD OF INVENTION

This invention relates to the class of computer graphics processing and selective visual display systems. Specifically, this invention relates to augmented reality systems that interact with print books.

### BACKGROUND OF INVENTION

Research shows that children who read books, away from school, have better reading skills, and will perform better in school, overall. The Educational Testing Services reported that students who do more reading at home are better readers and have higher math scores; however, students read less for fun as they get older. Additionally, with the advent of tablets, computers, and smartphones, children are reading less, generally, when they are away from school. According to a 2014 survey, the number of American children who say they love to read for fun has decreased significantly. Technology is potentially impairing the desire of children to read on their own. However, technology also has a solution.

Augmented reality systems interact with the physical and virtual world, at the same time. An augmented reality system provides views, sounds, and other media associated with the physical (real) world, and supplements them with computer-generated media in the forms of graphics, animation, sound clips, haptics, and the like. Augmented reality occurs in the real-time, meaning that the computer-generated media is super-imposed, in real-time, on physical world sensory perception. Augmented reality comes in many forms, from telestrators used on professional football telecasts, to heads-up-displays on fighter jets, to computer aided design, virtual reality headsets, and other similar applications.

Augmented reality can be used to enhance printed books, such as children's books. Current augmented reality systems for books rely on electronic books, usually with embedded chips and displays. The user has to buy an expensive augmented-reality (sometimes called interactive) specialty book. The cost of the current technology tends to limit users' libraries, because of the cost of each individual book can be prohibitive compared to print books. More importantly, the huge, installed base of current printed books is automatically excluded from the current augmented reality technology.

Additionally, current augmented reality books are fixed in time. The book cannot be adapted, updated, or changed. Current augmented reality books do not allow the user to create content to interact with the text and augmented reality media. This limits the user's interest in repetitively using the augmented reality book in much the same way that print books inhibit repetitive use, because the content is fixed and unchanging. The limitations of current technology can be seen in that market acceptance of the current augmented reality books is low. None of the current solutions have achieved mass-market appeal.

### PRIOR ART REVIEW

To truly meet the market demand, an augmented reality book should work with pre-existing print books, and it should allow users to create and store their own content, including avatars. Such an augmented reality system will benefit both users and the publishers of print books. There is substantial prior art in augmented reality, but seemingly almost none related directly to using augmented reality for pre-existing, printed books.

There is prior art related to using augmented reality to assist with printing documents or making presentations of documents. For example, U.S. Utility Pat. No. 7,769,772, by named inventors Weyl, et. al, entitled, “Mixed media reality brokerage network with layout-independent recognition,” teaches a system of making a mixed media document from a print document and an electronic document, such as a picture, movie, or web link.

Some patents teach methods of using image capture to identify documents or to capture image patches. For example, U.S. Utility Pat. No. 8,600,989, by named inventors Hull, et. al, entitled, “Method and system for image matching in a mixed media environment,” teaches a method and system for identifying a page or document using an image or text patch of a page or document.

Augmented reality has been used to help with translation. For example, U.S. Utility Pat. No. 8,965,129, by named inventors Rogoski, et. al, entitled, “Systems and methods for determining and displaying multi-line foreign language translations in real time on mobile devices,” teaches a method and system using a video feed in real time to capture one or more text lines in a bounding box, using shape and other attributes to determine the actual text, and then translating the text, displaying the translation on top of the video feed.

Augmented reality prior art has disclosed methods for putting metadata on top of an image of a document. For example, U.S. Utility Pat. No. 8,405,871, by named inventors Smith, et. al, entitled, “Augmented reality dynamic plots techniques for producing and interacting in Augmented Reality with paper plots for which accompanying metadata is accessible,” teaches a method and system using a printed plot, metadata, and a mobile electronic device to capture a picture of a printed plot, superimpose metadata on it, and then allow the user to make further annotations. This invention is designed for use in a construction context.

Some of the augmented reality prior art teaches methods for recalling content from an image/record library. For example, U.S. Patent Application Publication No. 20130093759, by named inventor Bailey, entitled, “Augmented Reality Display Apparatus And Related Methods Using Database Record Data,” teaches a system and method that captures an image, sends the image to a database, identifies a record based on the image, supplies the record to the display, and superimposes the record on top of and/or with the image on a display device.

Last, there are several applications that have electronic books which are augmented reality enabled, among them the following: U.S. Patent Application Publication No. 20130201185 (Sony electronic book); U.S. Patent Application Publication No. 20140002497 (Sony electronic book); and U.S. Patent Application Publication 20140210710 (Samsung electronic book). Although there is significant prior art related to augmented reality superimposed on top of a captured image, there is none that directs this technology towards pre-existing printed books, allowing pre-existing printed books to have augmented reality superimposed on top of it.

### SUMMARY OF THE INVENTION

This summary is intended to illustrate and teach the present invention, and not limit its scope or application. The present invention is an augmented reality system for use with pre-existing printed books. The user would view the augmented reality by viewing a page of the pre-existing printed book using a resident software application on a user electronic appliance such as a mobile phone, a tablet, augmented reality goggles, laptop computer, monitor and camera, or any other fixed or mobile electronics possessing a display, a camera, a processing unit, and a communications means. The user electronic appliance resident software application would interact with a remote source provider such as a database and server configuration. The augmented reality system would store media for each page of a book within a database. The media associated with a particular page would be transmitted to the user electronic appliance from the remote source provider using a communication means. The communication means can be accomplished by a communication chain including one or more of the following: cellular phone, wi-fi, Bluetooth, internet, Wide-area Network (“WAN”), Local-area Network (“LAN”), Personal-area Network (“PAN”), gaming console, and/or entertainment system.

Each page of a book is saved as a unique identifier. An image is taken of a page of a book. A number of features, such as pictures, graphics, text indents, page numbers, text, text patterns, relative location of pairs of letters, and location of particular letters on a page are identified from the image. A unique identifier for the page is created from one or more of the features.

The spine, cover, and ISDN can be associated with a particular title and the associated set of unique page identifiers. The spine, cover, and ISDN can be used to speed the loading of a book. For example, when the user device sees a book spine or cover, the appropriate augment reality for all pages associated with that spine or cover are requested from the server and loaded. The spine, cover, and ISDN can also be used to help a user find books that have available augmented reality. For example, a user can use a cellphone or other mobile device with image capture capability to identify printed books for which the augmented reality within the application exists. The user electronic appliance will then superimpose augmented reality, such as highlighting, over the printed book's title or spine. Other methods of associating printed books with the associated augmented reality database can be used, such as RFID, magnetic ink, magnetic strips, ultraviolet or infrared ink. For example, with library books containing RFID chips, the application can read the RFID chip and identify if the book is associated with a record augmented reality database.

The augmented reality can be viewed on a user electronic appliance, such as a cellphone, tablet, computer, augmented reality goggle, or any other portable or fixed user electronics that has the appropriate display, image capture, processing, memory, and communication capabilities. The user electronic appliance needs to provide sufficient hardware resources for the resident end-user application.

Each page of a printed book is associated with a record. The record contains, at a minimum, the image of the printed page, the unique identifier, and a multi-media presentation. A stored augmented reality multi-media presentation can include, but is not limited to, video, animation, stop motion animation, pictures, graphics, sounds, images, and vibrations. The stored augmented reality multi-media presentation can be supplemented with images, characters, graphics, sound effects, and other media created by a user and stored in that user's library. The user can, also, make an avatar. The stored augmented reality multi-media presentation can be supplemented with the avatar, and the avatar can interact with the stored augmented reality multi-media presentation through a variety of interfaces, such as a touch screen, keyboard, device movement, mouse, and user motion (e.g., waving hands or feet). The avatar, and the multi-media presentation, itself, can be triggered by sound, movement of the user, movement of the user electronic appliance, or other video, audio, or haptic means. The stored augmented reality multi-media presentation may also interact with the avatar without user interaction, allowing the reader to be pulled into the augmented reality portion of the story. The augmented reality system can store prior user animations, avatars, and interactions, so that each use of a particular title can proceed from where the prior use ended. The user can also decide to start, anew, at any time.

The stored augmented reality and supplemental library and avatar can be rendered using either proprietary, purchased, or open source rendering solutions. Rendering for each page is performed by associating the unique digital identifier for each page with a stored multi-media presentation on the server. Upon the application, resident on the user electronic appliance, requesting a particular title, portions of the record, including the multi-media presentation, can be transmitted, via the communication means, for quick loading. In order to speed loading of rendered multi-media, the application software can also use video layering, allowing each layer to launch independently. The multi-media logic can track whether certain layers have rendered, and are thus available for interaction by the user, or use by the stored multi-media presentation. The rendering system can be created so that augmented reality starts before the entire page or book is downloaded, thus speeding the user's interaction.

To speed loading, the application can also identify such information as where the user started a prior session, where the user ended a prior session, what is the most viewed page, and what is the center page (many books fall open to a center page). The information can then be used to prioritize the loading of certain pages. In this way, the system can be ready for use while it is still downloading information from the remote server.

The library of digital assets related to augmented reality is very large. As a result, the information may be transmitted using either lossy or lossless data compression techniques. With lossy compression techniques, the loss in fidelity will be acceptable for certain device sizes, such as cellphones. The tradeoff in such a case between a lossy compression technique and the speed of transmission and loading will be acceptable. When higher media fidelity is desired, loseless compression can be used.

During a session, all user created animation and media can be stored, so that when the user goes back to a previous page, all of the graphics are there. Logic can be embedded within the augmented reality that allows it to extrapolate position and interaction of user created media on each new page. This will allow user-created augmented-reality to be placed on a new page, ready for use upon page flip. At the end of a session, all of the user's interactions and all of the user-created media can be stored as input to the next user session with a particular title. With such a system, it will not matter if a user proceeds non-linearly through a session, as each page is stored independently, and the user-created media is interpolated and/or extrapolated onto each new page.

The augmented reality can be implemented with use-context logic, so that certain media is provided, excluded or modified based on the use context detected. Use context can include random page flipping, shaking or moving the electronic device, user inaction, user hyper-action, etc.

The augmented reality system and method can gather use data for printed text. For example, the system and method will collect information about what books kids read, which ones they read repetitively, which books they read “together” (in a single reading session), what parts of books they engage with most (at the page level and even at the interaction level), how frequently they read specific titles, etc. The system will generate and analyze non-self-reported reading habits. The aggregated data is assembled by usage independent variables, that includes, but is not limited to, theme, sex of reader, age-group, reading level, user electronic appliance type, geography, time of day, length of session, total word-count, word-count per page, font size, font type, and illustration density. Dependent variables can include, but are not limited to, frequency of title being read, repetitive reading of title, page interaction, book cross-correlation, duration of time spent with title, duration of time spent on each page of title, and motion (whether image is stable or moved around). Data analytics can then be used to help publishers identify popular themes.

### BRIEF DESCRIPTION OF THE DRAWINGS

FIG. 1 is a flow chart of a top-level software process.

FIG. 2 is a high level flowchart of a user validation sub-process.

FIG. 3 is a high level flowchart of a title identification sub-process.

FIG. 4 is a high level flowchart of a page loading sub-process.

FIG. 5 is a high level flowchart of a runtime sub-process.

FIG. 6 is a system communication diagram.

FIG. 7A is a display showing available books. FIG. 7B is a display showing a user's library.

FIG. 8 is a diagram of a user using the invention.

FIG. 9 is a diagram showing the presentation layers of the invention.

FIG. 10 is a system block diagram.

### DETAILED DESCRIPTION OF THE DRAWINGS

The following descriptions are not meant to limit the invention, but rather to add to the summary of invention, and illustrate the system and method for displaying augmented reality for a standard print book. The system and method presented with the drawings is one potential system and method for implementing augmented reality with a standard print book.

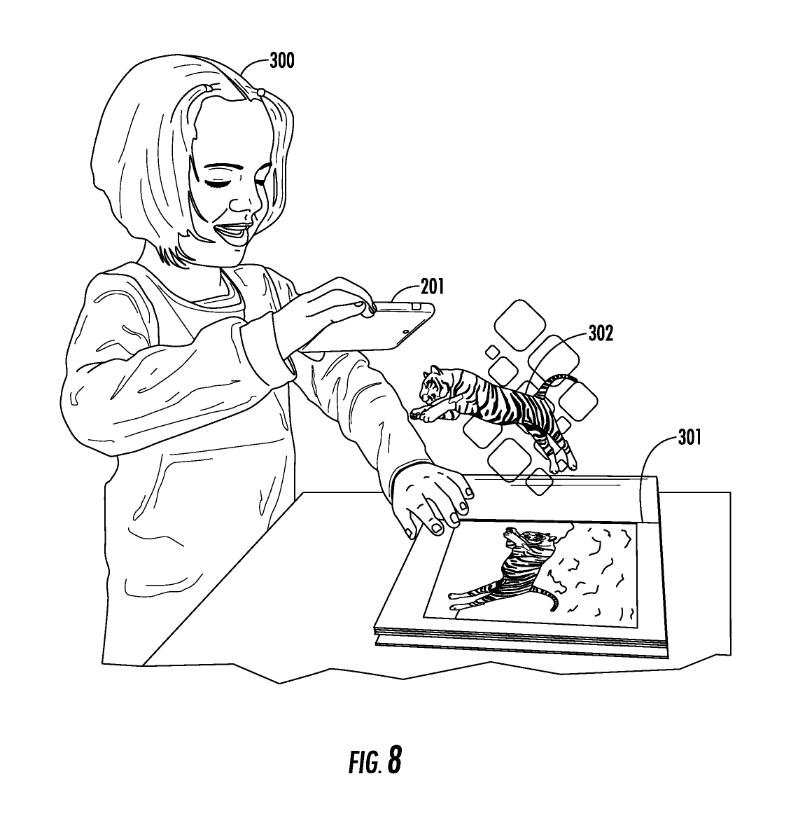

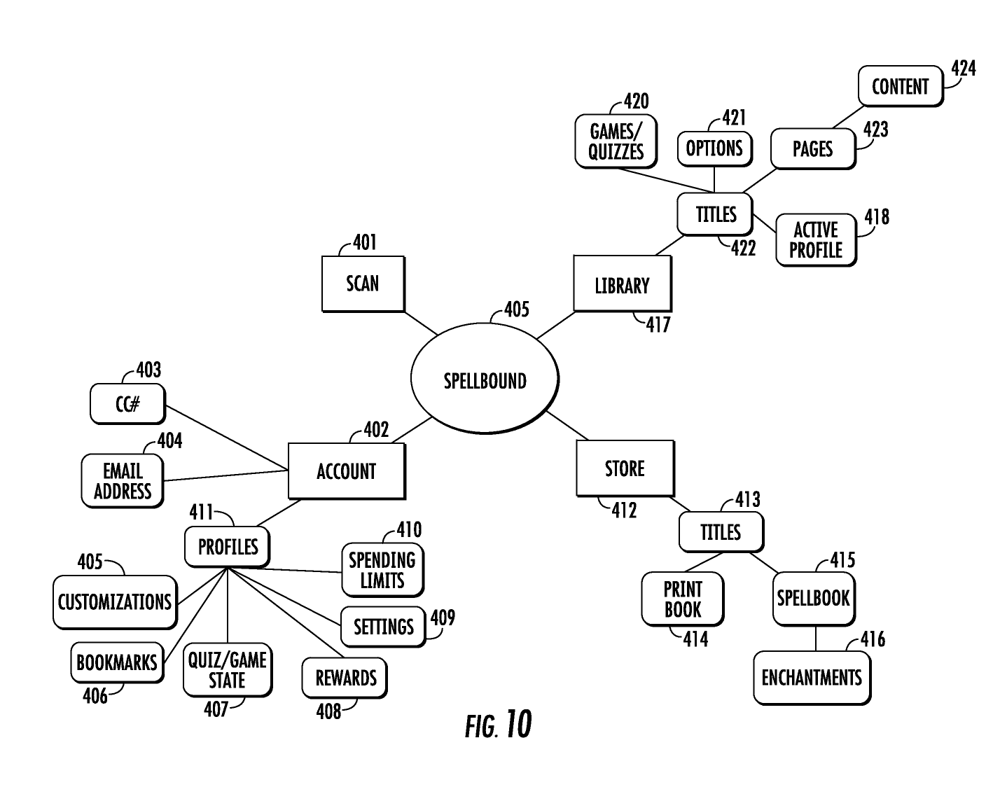

FIG. 10 shows a high-level block system diagram of the software method architecture used by the present invention. The framework 400 of the system is referred to as Spellbound™ 400. Spellbound™ 400 is connected to a routine to scan 401, a user library 411, a user account 402, and a store 412. The scan 401 routine allows the user to focus a user electronic appliance 201 (see FIG. 8) over the page of a printed book 301 (see FIG. 8). The Spellbound™ 400 application then uses a unique visual identifier to identify library content 419, or titles 413 available from the store 412, which correspond to the unique visual identifier.

The user library 419 has printed book titles 422. Each printed book title 422 has associated pages 423, options 421, games/quizzes 420, and active profile 418. The pages 423 include user content 424. The user account 402 has a profile 411, an e-mail address 404, and payment information 403. The profile 411 includes spending limits 410, settings 409, rewards 408, quiz/game state 407, bookmarks 406, and customizations 405. The store 412 has titles 413 for purchase. Each title 413 has an associated print book 414, and a spellbook 415. Each spellbook 415 has enchantments 416.

FIG. 8 shows a user 300 reading a print book 301 with the spellbook 415 enchantments 416 presented as a three-dimensional animation 302 jumping off of the page of the printed book 301. The user 300 holds the user electronic appliance 201 through which the user 300 can see the enchantments 416, 302 of the spellbook 415 super-imposed on the printed book 301. The user can trigger new enchantments 416 through her actions, including the action of turning the page. Other triggers that would result in new media or enchantments 416 being loaded include the user 300 reading portions of the book 301 out loud, clapping, whistling, blowing, moving the book, and moving the user electronic appliance 201. User 300 context can also act as a trigger. For example, inaction, switching the user electronic appliance 201 between two books, repetitive page flipping, and random page flipping can also be used as triggers.

The enchantments 416, 302 can include a video component, an audio component, and a haptic component. The video component can be displayed on the user electronic appliance 201 display screen. The video component can be flat, static graphics in plane with the page; flat animation in plane with the page; flat, static graphics raised above the page; flat animation raised above the page; three-dimensional, static graphics coming out of the page; three-dimensional animation coming out of the page; three-dimensional, static graphics projecting into the page; and three-dimensional animation projecting into the page.

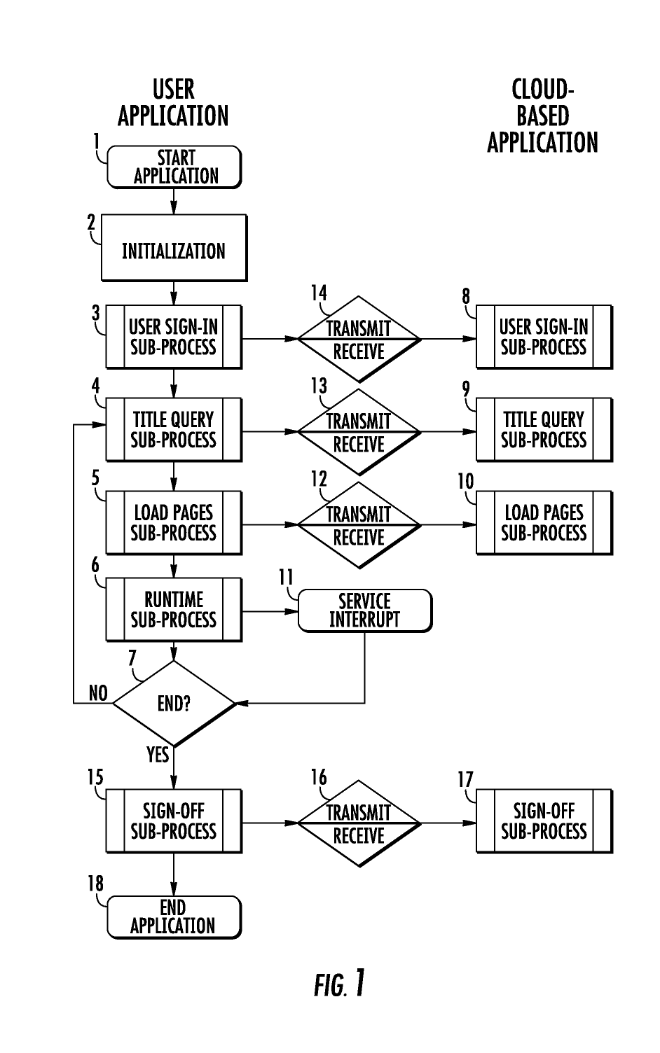

FIGS. 1-5 define parallel User Application software processes and Cloud-Based Application processes for use in an augmented reality system for printed books. The embodiment presented, herein, is illustrative, only. Modules, routines, functions, and processes can be implemented as either a User Application, Cloud-Based Application, or a combination of both.

The User Application and Cloud-Based Application need to perform, at a minimum, four parallel sub-processes: sign-in, title query, page loading, and sign-off. In addition, the User Application needs to perform, at a minimum an additional runtime sub-process. These sub-processes are managed and launched by a top-level process. FIG. 1 shows the top-level, high-level flowchart for a system for delivering augmented reality to a printed book. The user (see, e.g., FIG. 8, 300) would start 1 the user application on the user electronic appliance (see e.g., FIG. 8, 201). The User Application would initialize 2, and then launch a Sign-In Sub-Process 3.

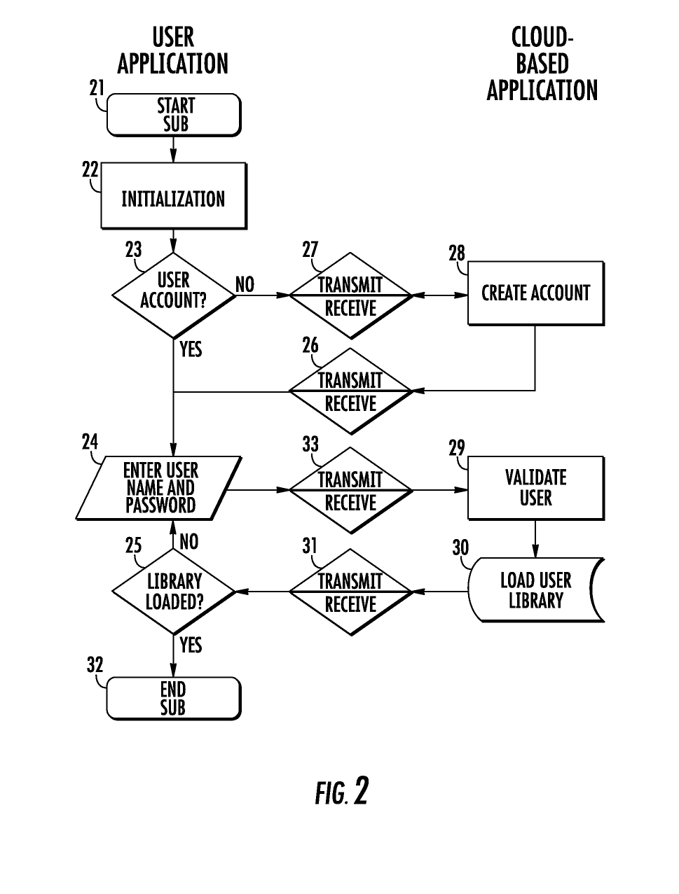

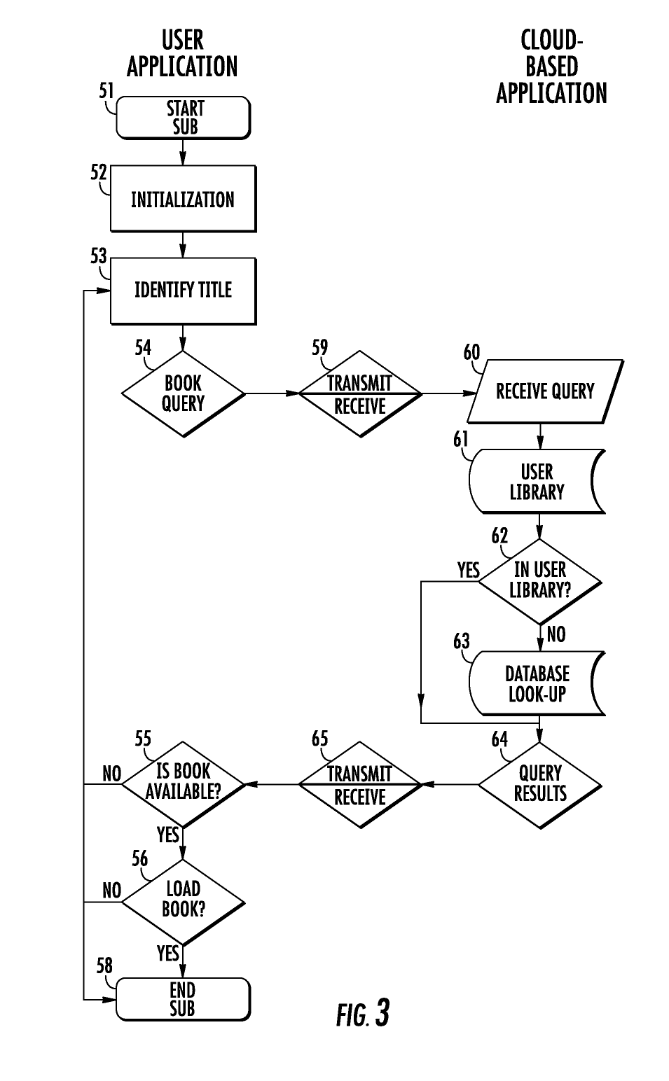

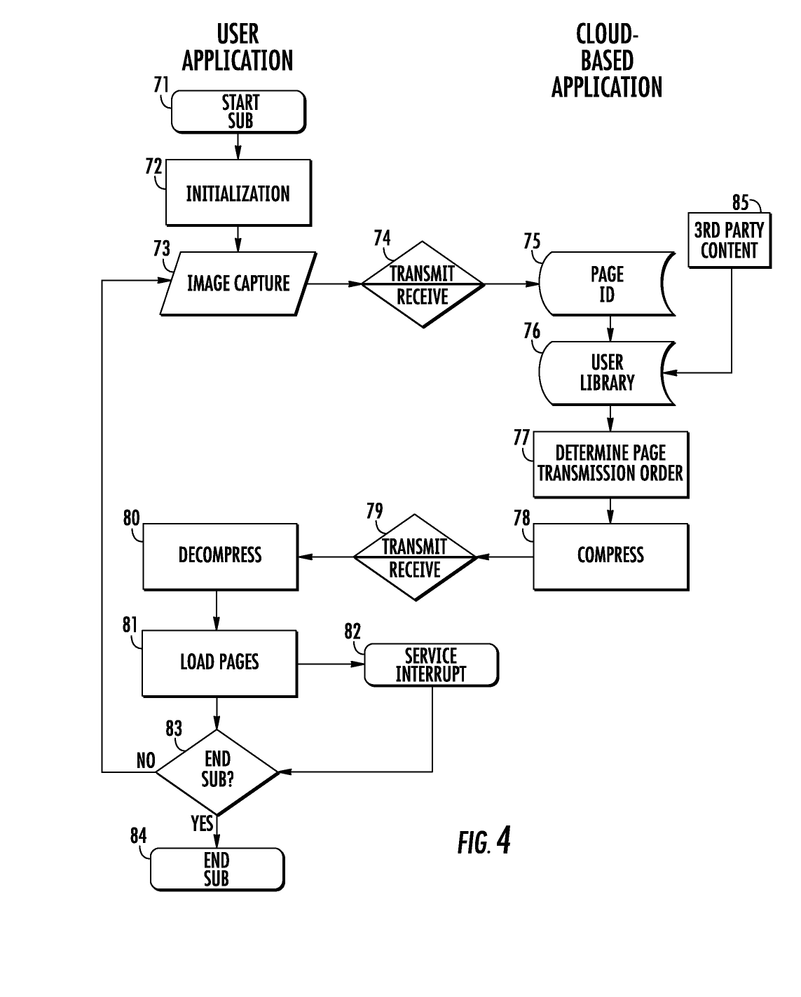

The User Application Sign-In Sub-Process 3 transmits and receives 14 information to/from a Cloud-Based Application Sign-In Sub-Process 8, which validates the user. The Sign-In Sub-Process 3, 14, 8 is presented in more detail in FIG. 2. After validation or approval is received from the Sign-In Sub-Process 3, 14, 8, the User Application launches a Title Query Sub-Process 4. The User Application Title Query Sub-Process 4 transmits and receives 13 information to/from a Cloud-Based Application Title Query Sub-Process 9. The Title Query Sub-Process 4, 13, 9 is presented in more detail in FIG. 3. After the Title Query 4, 13, 9 confirms that a title is available for augmented reality, the User Application launches a Load Pages Sub-Process 5. The User Application Load Pages Sub-Process 5 transmits and receives 12 information to/from a Cloud-Based Application Load-Pages Sub-Process 10. The user 300 has to use a user electronic appliance 201 to capture an image of a book or page. The image of a page is associated with a page unique visual identifier for that page. The information received from the Cloud-Based Application Load-Pages Sub-Process 10 is the record associated with each page unique visual identifier. The record contains a multi-media presentation associated with a page of text, which, in turn, is associated with the page unique visual identifier. The Load Pages Sub-Process 5, 12, 10, is presented in more detail in FIG. 4.

After the Load Pages Sub-Process 5, 12, 10 loads augmented reality information associated with one or more pages, the User Application launches a Runtime Sub-Process 6. The User Application can proceed independently of the Cloud-Based Application while executing the Runtime Sub-Process 6. The User Application Runtime Sub-Process 6 presents the user 300 with augmented reality associated with one or more pages of a printed book, using the record stored in a database, which is associated with a unique visual identifier corresponding to the page. The augmented reality multi-media presentation can be graphics, animation, sound, haptics, or other multimedia presented to the user electronic appliance 201. The Runtime Sub-Process is enabled with a Service Interrupt 11, which allows the User 300 to stop the augmented reality multimedia presentation. The Service Interrupt 11 can be implemented with a soft-key, hard-key, touch-screen, voice command, or haptic control.

Either when the Service Interrupt 11 is activated or the Runtime Sub-Process 6 terminates, the User 300 is presented with a choice to either end the session or continue with a new printed book through the use of a User Termination Control 7. The User Termination Control 7 can be implemented with a soft-key, hard-key, touch-screen, voice command, or haptic control.

When the User 300 terminates a session, either through action or inaction, the User Application launches a Sign-Off Sub-Process 15. The User Application Sign-Off Sub-Process 15 transmits and receives 16 to/from a Cloud-Based Application Sign-Off Sub-Process. The Sign-Off Sub-Process 15, 16, 17 ends the User's 300 session and stores any user-created content or new printed books in the User's 300 library 419. This ends 8 the main process.

FIG. 2 is a high-level flowchart of the Sign-In Sub-Process 3, 14, 8 discussed pursuant to FIG. 1. The sub-process starts 21 and is initialized 22, passing any necessary variables. The user 300 (or, realistically, the user's 300 parent) is given a choice to create a new account 23 or enter the user's 300 name and password 24. The information is transmitted 26, 27, 33 to the Cloud-Based Application, where it serves as the input to the appropriate function, either Create Account 28 or Validate User 29. If the User 300 creates a new account 23, 27, 28, the Cloud-Based Application transmits 26 a prompt to the User Application to ask the User 300 to enter their name and password 24, after creating a new account 28. If the User 300 provides the correct user name and password 24, which is transmitted 33 to the Cloud-Based Application, the Validate User 29 function will Load User Library 30. Load User Library 30 then transmits 31 the User's library to the User Application. The User Application knows to end the sub-process when the library is loaded 25, 32.

FIG. 3 is a high-level flowchart of the Title Query Sub-Process 4, 13, 9 discussed pursuant to FIG. 1. The sub-process starts 51 and is initialized 52, passing any necessary variables or information. The user 300 gives the User Application input to Identify Title 53, including, but not limited to, the following: typing in a title, using an image of the title or spine of the book, sensing an RFID or other near-field chip, sensing magnetic ink or strip, or sensing infrared or ultra-violet ink. The User Application identifies the Book Query 54 and transmits and receives 59 information from the Cloud-Based Application, which Receives Query 65. The Cloud-Based Application determines if the title is in the User Library 61, 62. If the title is available in the User Library 61, this result is loaded as the Query Results 64. If the title is not present in the User Library 61, the sub-process performs a Database Look-up 63 to determine if the title is available for augmented reality treatment, and loads this as the Query Results 64. The Query Results 64 is transmitted 65 to the User Application, which uses the Query Results 64 to determine if the Book is Available 55. If the Book is Available 55, the User 300 is asked if they want to Load Book 56. If the User 300 wants to Load Book 56, the result is passed as the value from the sub-process, and the sub-process ends 58. If the User 300 does not want to load the title 56, or if the book is not available 55, the User 300 can search another title 53 or end the process 58.

FIG. 4 shows the Load Pages Sub-Process 5, 12, 10. The sub-process starts 71 and initializes 72 with positive query results 56 from the Title Query Sub-Process 4, 13, 9. The User 300 prompts the User Application to proceed by capturing an image 73 of a page using the user electronic appliance 201. This is transmitted 74 to the Cloud-Based Application, which searches the database for a Page ID 75. The augmented reality is supplemented with information from the User Library 76. The Cloud-Based Application will Determine Page Transmission Order 77 based off of the page from the Image Capture 73 and from the User Library 76. The information will be compressed 78 and transmitted 79 to the user electronic appliance 201, where it will be decompressed 80 by the user application. The pages will be loaded 81 in a process with a Service Interrupt 82. If the Service Interrupt 82 stops the Load Pages 81 routine, the user Application will allow the user 300 to end the sub-process 83,84, or go back to Image Capture 73. If Load Pages 81 successfully loads the page(s), the Sub-Process will end successfully 83, 84.

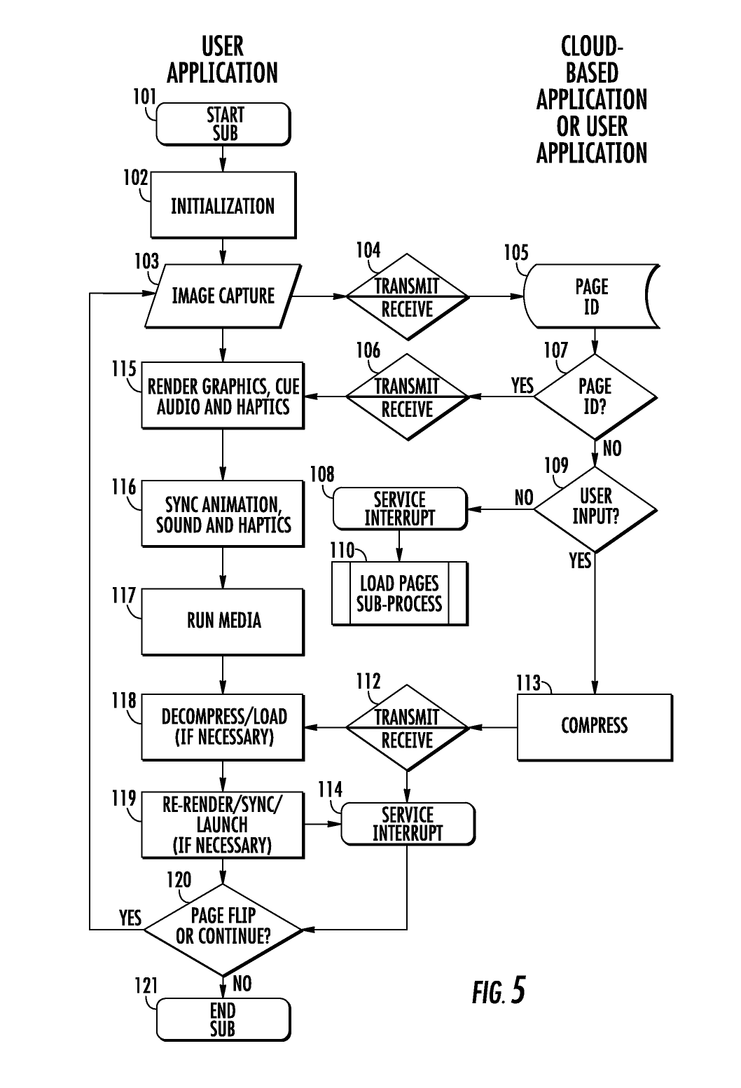

FIG. 5 shows the Runtime Sub-Process 6, which has a Service Interrupt 11, 108, 114. In FIG. 5, the Runtime Sub-Process 6 starts 101 and is initialized 102. The Image Capture 103 has augmented reality super-imposed on it by the User Application. This is done by Rendering Graphics, Cue Audio and Haptics 115. The User Application Syncs Animation, Sound and Haptics 116, and then Runs Media 117. The User Application can begin Runs Media 117, prior to all layers of graphics being rendered. So although Rendering Graphics, Cue Audio and Haptics 115, Syncs Animation, Sound and Haptics 116, and Runs Media 117 are shown as sequential processes, they can be launched and executed as a partial parallel process. While the augmented reality multi-media presentation on the user electronic appliance Renders 115, Syncs 116, and Runs 117, the user application transmits 104 the Image Capture 103 to the Cloud-Based Application. The Page ID 105 is confirmed 107, 106, prior to Rendering Graphics 115. If the Image Capture 103 does not match the Page ID 105, 107 the Cloud-Based Application determines if the difference is from User Input 109. If it is, the User Input 109 is Compressed 113 and transmitted 110. The user application then Decompress/Loads 118 and Re-renders/Sync/Launch 119. At the end of the runtime, the User Application prompts the User 300 to Flip Page or Continue 120. If the User 120 decides to end, the Sub-Process Ends 121.

During the Runtime Sub-Process, if the Pages ID 107 is not confirmed, and the difference is not User Input 109, the Cloud-Based Application sends a Service Interrupt 108 to the user application, and the user application re-enters the Load Pages Sub-Process 108, 5, 12, 10 or is given a choice to continue in the Runtime Sub-Process 108, 114, 120.

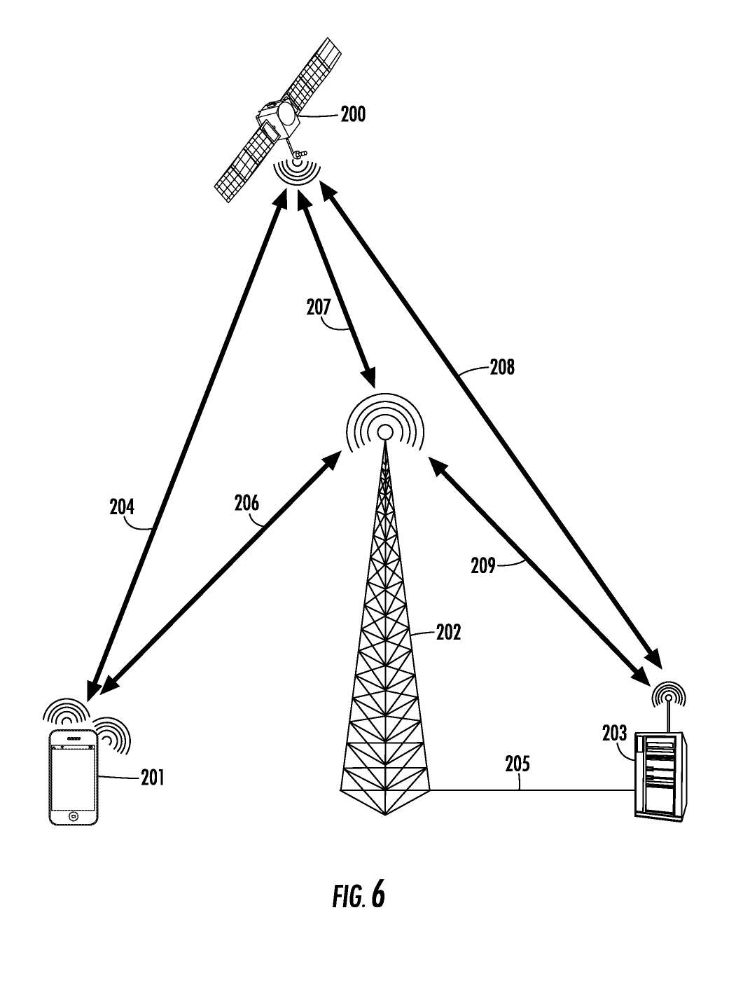

FIG. 6 shows multiple communication paths between the user electronic appliance 201, containing the User Application, and the server 203 containing the Cloud-Based Application from FIGS. 1-5. The user electronic appliance 201 can communicate 204 with a satellite 200, which in turn communicates 207 with a cell network tower 202 which can then wirelessly communicate 209 with the server 203, or can communicate 205 through the internet or other tangible connection to the server 203. The satellite 200 can also communicate directly with the server 203, if so enabled. This is meant to be illustrative in the communication methods that could connect the user electronic appliance 201, containing the User Application, to the server 203, containing the Cloud-Based Application, and is not meant to suggest that this is an exhaustive set of the communication links between the user electronic appliance 201 and the server 203.

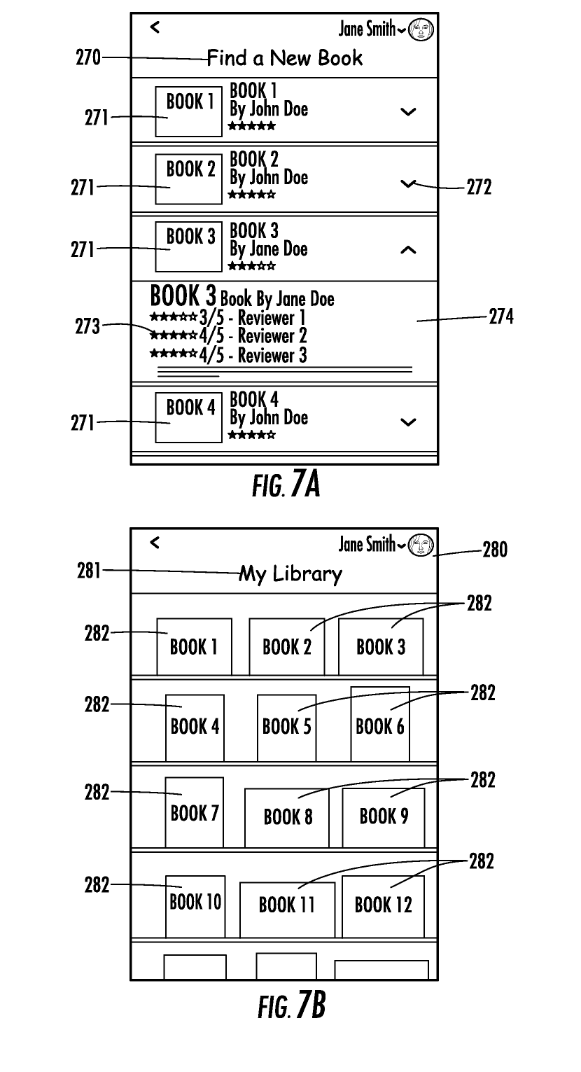

FIG. 7A shows a display of a store 412 in which a user would find 270 a new book 271. The virtual store 412 would have arrows 272 that can offer expanded content 274 such as reviews 273 or descriptions of the books 271.

FIG. 7B shows a user library 419, represented graphically 281. The graphical user library 281 shows the plurality of books 282 that the user has purchased. The books 282 allow the user to experience multi-media presentations super-imposed on top of the print book 414, 301. The multi-media presentation is referred to as a spellbook 415. Each spellbook 415 has particular triggerable content called enchantments 416.

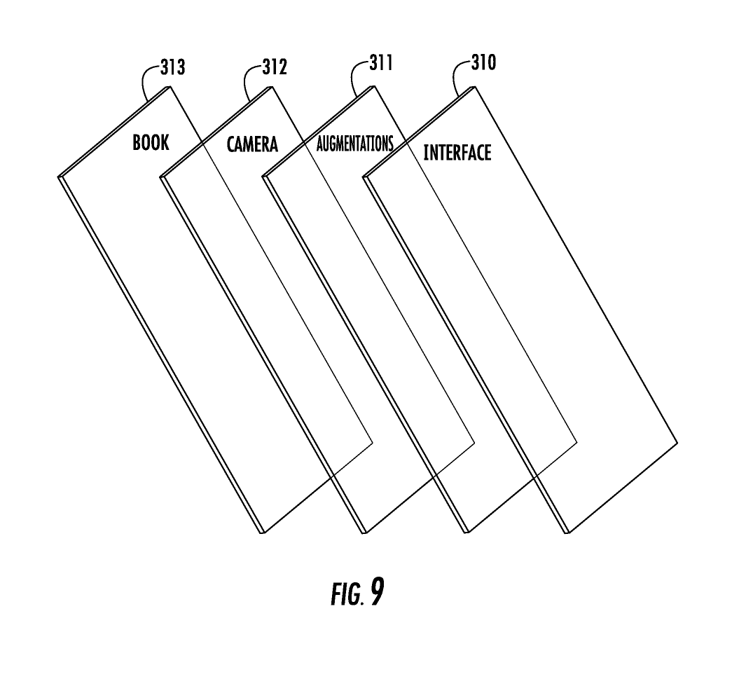

FIG. 9 shows the layers that can be presented. The invention contains at least graphic layers for the book 313, camera 312, augmentations or enchantments 311, 416, and interface 310. The book 313, camera 312, augmentations or enchantments 311, 416, and interface 310 can be super-imposed, one on top of the other. When a new page loads, each of the graphic layers be displayed as soon as it renders, meaning that the layers can be added during runtime, as each new layer is successively rendered.

We claim:

1. A system to provide multi-media augmented reality for printed books comprising a user electronic appliance, the user electronic appliance being comprised of a display, image capture device, a software application, embodied on a non-transitory computer readable medium, and a transmission means;
a server processing device connected to the user electronic appliance via the transmission means;
a database connected to the server processing device;
and a software method, embodied on a non-transitory computer readable medium, accessible to the server processing device, capable of identifying a printed page by a unique visual identifier, associating the unique visual identifier with a unique augmented reality record containing an embedded multi-media presentation stored in the database, and capable of transmitting the augmented reality record, via the transmission means, to the user electronic appliance;
wherein the software application resident on the user electronic appliance is capable of running the multi-media presentation on the display of the user electronic appliance, superimposing the multi-media presentation over a real-time image of the page associated with the augmented reality record by the unique visual identifier.

2. The system to provide multi-media augmented reality for printed books in claim 1, wherein the multi-media presentation is comprised of a visual component and an audio component, that are time-synchronized.

3. The system to provide multi-media augmented reality for printed books in claim 2, wherein the visual component of the multi-media presentation is at least one of the following: flat, static graphics in plane with the page; flat animation in plane with the page; flat, static graphics raised above the page; flat animation raised above the page; three-dimensional, static graphics coming out of the page; three-dimensional animation coming out of the page; three-dimensional, static graphics projecting into the page; and three-dimensional animation projecting into the page.

4. The system to provide multi-media augmented reality for printed books in claim 3, wherein the software application resident on the user electronic appliance further comprises a method capable of
capturing an image of a page from a printed book through the image capture device;
transmitting the image through the transmission means to the server processing device;
receiving, in return, the record, composed of a multi-media presentation, from the server processing device;
rendering the visual component of the multi-media presentation, embedded in the record, on the display unit by super-imposing the visual component of the multi-media presentation over an image of the printed page; and
displaying a graphic interface layer, super-imposed over both the image of the printed page and the multi-media presentation, wherein the graphic interface layer controls the software application resident on the user electronic appliance.

5. The system to provide multi-media augmented reality for printed books in claim 2, wherein the user electronic appliance is further comprised of an audio output device, capable of producing audible sounds; and wherein the software application resident on the user electronic appliance further comprises a method capable of playing the audio component of the multi-media presentation over the audio output device.

6. The system to provide multi-media augmented reality for printed books in claim 1, wherein the software method accessible to the server processing device is further comprised of the capability of
creating a unique page identifier for a plurality of pages of a printed book;
associating the unique page identifiers with an augmented reality record containing a multi-media presentations;
determining the unique page identifier corresponding to an image transmitted from the image capture device;
accessing the augmented reality record corresponding to an image transmitted from the image capture device; and
transmitting the augmented reality record, associated with the unique page identifier, to the user electronic appliance.

7. The system to provide multi-media augmented reality for printed books in claim 6, wherein the software method accessible to the server processing device is further comprised of the capability of compressing an augmented reality record; and wherein the software application resident on the user electronic appliance further comprises a method capable of decompressing the augmented reality record.

8. The system to provide multi-media augmented reality for printed books in claim 7, in which the compression is lossless.

9. The system to provide multi-media augmented reality for printed books in claim 7, in which the compression is lossy.

10. The system to provide multi-media augmented reality for printed books in claim 1, wherein the software method accessible to the server processing device and the software application resident on the user electronic appliance are further comprised of the capability of loading a plurality of augmented reality records, associated with a plurality of unique page identifiers, into the user electronic appliance, based on at least one of the following: the user's behavior, the user's input, the unique page identifier, a trigger, and user context.

11. The system to provide multi-media augmented reality for printed books in claim 10, wherein the trigger is at least one of the following sounds: the user audibly reading a page of printed text associated with a unique page identifier, clapping, blowing into a microphone, singing, and a responsive audible answer to a question posed by the multi-media presentation.

12. The system to provide multi-media augmented reality for printed books in claim 1, wherein the software method accessible to the server processing device and the software application resident on the user electronic appliance are further comprised of the capability of identifying printed book titles, and associating the printed book titles with a plurality of unique page identifiers.

13. The system to provide multi-media augmented reality for printed books in claim 12, wherein the printed book title is identified, in part, by using the image capture device to capture an image of either the cover or spine of the book.

14. The system to provide multi-media augmented reality for printed books in claim 12, wherein the printed book title is identified using at least one of an RFID chip, a near-field chip not classified as an RFID chip, a magnetic strip, magnetic ink, ultraviolet ink, and infrared ink.

15. The system to provide multi-media augmented reality for printed books in claim 3, wherein the visual component of the multi-media presentation is rendered in layers, capable of being super-imposed on top of one another.

16. The system to provide multi-media augmented reality for printed books in claim 13, wherein the layers may be presented to the user, individually.

17. The system to provide multi-media augmented reality for printed books in claim 16, wherein one layer may be presented to the user, while the other layers are still being rendered.

18. The system to provide multi-media augmented reality for printed books in claim 1, wherein user information is stored in the user electronic appliance and in the database accessible to the server processing device; and wherein the user information contains at least one of a user library and a user account.

19. The system to provide multi-media augmented reality for printed books in claim 18, wherein the user may add graphics, sounds, haptics, or other media, to multi-media presentation.

20. The system to provide multi-media augmented reality for printed books in claim 19, wherein user created content is stored in the user library.

21. The system to provide multi-media augmented reality for printed books in claim 20, wherein the user is able to make an avatar, which represents the user and can be added to the multi-media presentation.

22. The system to provide multi-media augmented reality for printed books in claim 18, wherein the user library gives the user access to third-party multi-media content.

23. The system to provide multi-media augmented reality for printed books in claim 1, wherein information about the user's reading habits are gathered and stored.

24. The system to provide multi-media augmented reality for printed books in claim 23, wherein the information about the user's reading habits are aggregated with the reading information about other users' reading habits.

25. The system to provide multi-media augmented reality for printed books in claim 1, wherein the unique visual identifier for a printed page is created from at least one of an image, text, text pattern, relative location of pairs of letters, and locations of particular letters.

26. The system to provide multi-media augmented reality for printed books in claim 1, wherein the user electronic appliance is further comprised of a gyroscopic sensor.

27. The system to provide multi-media augmented reality for printed books in claim 26, wherein information from the gyroscopic sensor is used to determine movement of the user electronic appliance with respect to the printed book.

28. The system to provide multi-media augmented reality for printed books in claim 27, wherein information from the gyroscopic sensor is used to adjust the size and aspect ratio of the video component of the multi-media presentation.

29. The system to provide multi-media augmented reality for printed books in claim 1, wherein the multi-media presentation includes at least two of the following: video, animation, stop motion animation, pictures, graphics, sounds, images, or vibrations.

30. The system to provide multi-media augmented reality for printed books in claim 3, wherein the multi-media presentation is presented to the user using use-context logic, wherein the use-context logic determines whether certain media is provided, excluded or modified based on the use context detected.

31. The system to provide multi-media augmented reality for printed books in claim 30, wherein the use-context logic detects one or more of the following: random page flipping, shaking or moving the user electronic appliance, user inaction, user hyper-action, repetitive page flipping (e.g., between two pages), and simultaneous use of multiple titles.

32. The system to provide multi-media augmented reality for printed books in claim 31, wherein the multi-media presentation can change based off of the user's behavior.
